(19) United States
(12) Patent Application Publication
(10) Pub. No.: US 2011/0158741 A1
(43) Pub. Date: Jun. 30, 2011

(54) Nodal Member For A Frame Structure Nodal Assembly

(76) Inventor: Harald Knaebel, Karlsruhe (DE)

(21) Appl. No.: 12/831,781

(22) Filed: Jul. 7, 2010

(30) Foreign Application Priority Data
Sep. 22, 2009 (DE) 10 2009 029 657.3

(51) Int. Cl. F16B 17/00; B32B 37/12

(52) U.S. Cl. 403/265; 156/293

(57) ABSTRACT

A nodal assembly, such as for a frame structure, includes a nodal member which has a fastening flange for connecting to a hollow frame member. An adhesive channel runs helically around an outer surface of the fastening flange, substantially transversely to a pushing-on direction of the frame member. The frame member is pushed onto the flange, and an adhesive is injecting into the adhesive channel via an adhesive injection opening formed in the frame member.

### FIELD OF THE INVENTION

The present invention relates to a nodal member for a frame structure.

### BACKGROUND OF THE INVENTION

A nodal assembly in the shape of a bonding socket is described in DE 94 19 777 U1. The bonding socket includes a receiving section for bonding a hollow member, wherein a self-contained distribution channel for the injection of an adhesive is formed on the inside of the receiving section. Injection of the adhesive is carried out via an injection opening formed in the bonding socket. In addition, the bonding socket includes an exit opening by means of which it can be checked if the distribution channel is adequately filled with adhesive. Because of the self-contained design of the distribution channel there is the possibility that the air present therein is only partially forced out when the adhesive is injected. Ultimately, this results in incomplete filling with adhesive of the distribution channel and thus fluctuating bonding results.

### SUMMARY

Accordingly, an object of this invention is to provide a nodal member which assures uniform bonding results.

This and other objects are achieved by the present invention, wherein a nodal assembly for a frame structure includes a nodal member with a fastening flange for connecting with a hollow frame member. The frame structure may be used as a vehicle frame structure, such as a vehicle cab frame. The fastening flange includes an adhesive channel which runs helically around, substantially transversely to a pushing-on direction of the frame member. The frame member includes an adhesive injection opening which communicates with the adhesive channel when the frame member is mounted on the flange. When adhesive is injected into the adhesive channel through the adhesive injection opening, the adhesive gradually spreads along the circumference of the fastening flange, with complete displacement of the air present in the adhesive channel. The air escapes via an adhesive inspection opening provided in the frame member, which, spaced from the adhesive injection opening, communicates with the adhesive channel. The adhesive is injected until adhesive is discharged from the adhesive inspection opening, so that it is ensured that the adhesive channel is completely filled with adhesive. Fluctuating bonding results due to undesirable air inclusions can be reliably avoided in this manner.

The adhesive can either be a one-component methylacrylate-based adhesive or a two-component epoxy-resin-based adhesive. In addition or alternatively, the use of anaerobically or thermally curing adhesives is also possible.

The adhesive channel preferably runs on the outside of the fastening flange of the nodal member. The inside of the frame member in this case is of a smooth finish, at least in a fastening region intended to receive the flange. The frame member is seamlessly drawn for example from a suitable steel alloy. Alternatively, it can also be a rolled member or—when using light-metal alloys—an extrusion.

For injecting the adhesive, the adhesive channel particularly includes an adhesive entry region and an adhesive exit region, wherein the two regions can be assigned to the two outer ends of the adhesive channel. By pushing and/or pressing the frame member onto the flange, the adhesive injection opening and the adhesive inspection opening formed in the frame member can be respectively brought into alignment with the adhesive entry region and the adhesive exit region of the adhesive channel. Preferably, the adhesive entry region and adhesive exit region are adapted in terms of their geometry to that of the adhesive injection opening and the adhesive inspection opening respectively of the frame member, so that defined entry and exit of the injected adhesive into and from the adhesive channel is ensured.

To establish a mechanical joining connection between the nodal member and the frame member, the frame member can be designed or dimensioned in such a manner that, when pushing-on and/or through subsequent shrinking-on or joining by thermal expansion, an elastic or plastic positive connection between the nodal member and the frame member is established. Shrinking-on or joining by thermal expansion of the frame member is generally carried out thermally, but alternatively magnetic forming of the frame member or hydroforming of the nodal member in the region of the fastening section can also take place. Establishing a crimped connection after the frame member has been pushed onto the nodal member is alto conceivable. In the latter case, the adhesive can be pre-applied in the adhesive channel, wherein preferably a so-called micro-encapsulated adhesive is used, which on establishing the crimped connection is pressure-activated.

Furthermore, it is possible that, because of the elastic or plastic positive connection, the frame member forms a bead at least partially engaging in the adhesive channel. The bead only engages in the adhesive channel to the extent that injection of the adhesive into the adhesive channel without problems is ensured. The mechanical joining connection not only has a stabilizing effect on the frame member but simultaneously fixes the frame member relative to the nodal member pending the complete curing of the adhesive injected into the adhesive channel.

The adhesive channel can be formed by adjacent turns of a helical ridge, which runs in the shape of a helix along the outside of the fastening flange substantially transversely to the pushing-on direction of the frame member. Here it is possible that the ridge, particularly designed as a unitary part of the nodal member, has a cross section tapering towards the outside, so that, on establishing the mechanical joining connection between the nodal member and the frame member, formation of the bead on the frame member is preferred.

In order to increase the resistance to twisting of the connection established between the frame member and the nodal member, the fastening flange may have a substantially rectangular cross section with respect to the pushing-on direction of the frame member. At least in the fastening region intended to receive the frame member, the nodal member, is provided with a corresponding rectangular cross section. It must be noted in this connection that, in principle, other cross-sectional shapes are also possible. Use of frame members with round cross section is also conceivable in the case of complex vehicle frame structures because of the better formability.

The nodal member consists of a suitable steel or light-metal alloy and can be manufactured unitarily as a casting and/or a forging or by hydroforming of a blank designed as a hollow member. Alternatively, a multi-part design is also conceivable, wherein the nodal member consists of a plurality of shell-shaped individual parts or member elements welded together. Depending on the intended use of the nodal member, a plurality of fastening flanges of different orientations and/or dimensions can be provided.

It is additionally possible that on the nodal member there is formed at least one carrier element, which is particularly provided for fastening body components and/or functional components to be attached to the vehicle frame structure. The carrier element is a unitary or integral part of the nodal member. If the vehicle frame structure is used for a driver's cab of an agricultural commercial vehicle, the body components can be different panel and cab parts and the functional components can be elements of a cab mounting or the like. In addition or alternatively it is also conceivable to use the frame members arranged between the nodal members as air guides of an air-conditioning device.

Preferably, the fastening flange of the nodal member has a tapering outer contour, so that simplified pre-assembly of the vehicle frame structure through loose positioning or pushing into each other of the frame members and nodal members is possible. The tapering outer contour can particularly be shaped conically.

### BRIEF DESCRIPTION OF THE DRAWINGS

FIG. 1 is a schematic view of a nodal assembly for a frame structure according to the invention;

FIG. 2 is a sectional view of the nodal assembly of FIG. 1 in a connected state;

and

FIG. 3 is a schematic view of an alternative embodiment of a nodal assembly according to the invention.

### DESCRIPTION OF THE PREFERRED EMBODIMENT

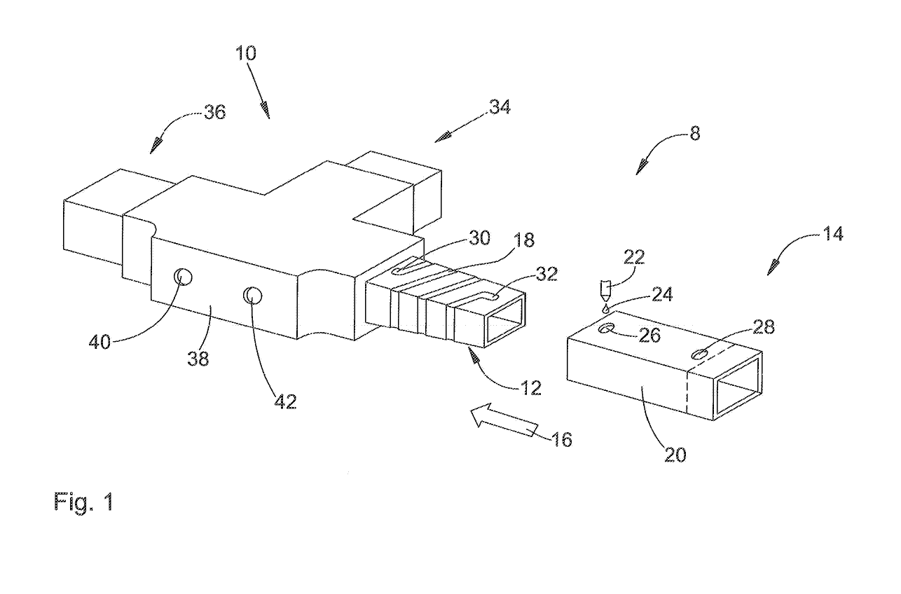

Referring to FIG. 1, a frame or nodal assembly 8 includes nodal member 10 for coupling to a hollow frame member 14. The nodal member 10 includes at least one fastener flange 12 for connecting with the hollow frame member 14. An adhesive channel 18 runs around the flange 12 in a direction substantially transversely to a pushing-on direction 16 of the frame member 14. For example, the adhesive channel 18 runs around the outer surface of the flange 12. With respect to the pushing-on direction 16 of the frame member 14, the flange 12 has a substantially rectangular cross sectional shape. Frame member 14 includes a fastening region 20 which receives the flange 12 and which also has a corresponding rectangular cross sectional shape. The inside of the frame member 14 is seamlessly drawn from a suitable steel alloy with a smooth finish, at least in the fastening region 20.

Frame member 14 includes an adhesive injection opening 26 and an adhesive inspection opening 28. The adhesive channel 18 includes an adhesive entry region 30 and an adhesive exit region 32, wherein the two regions 30 and 32 are located at the two outer ends of the adhesive channel 18.

When the flange 12 is received by the frame member 14, an adhesive 24 is injected by an injection socket 22 through adhesive injection opening 26 into the adhesive channel 18. The adhesive gradually spreads along the circumference of the fastening flange 12 and displaces the air present in the adhesive channel 18. The air escapes via the adhesive inspection opening 28. In order to support even and airless filling of the adhesive channel 18, a vacuum can be additionally generated in the region of the adhesive inspection opening 28 by means of a suction socket (not shown).

By pushing the frame member 14 onto the flange 12, the adhesive injection opening 26 will be aligned with the adhesive entry region 30, and the adhesive inspection opening 28 will be aligned with and the adhesive exit region 32. The adhesive entry region 30 and adhesive exit region 32 are constructed so that defined entry and exit of the injected adhesive 24 into and from the adhesive channel 19 is ensured.

The nodal member 10 is preferably made out of a. steel or light-metal alloy and is manufactured unitarily as a casting and/or a forging or hydro-forming of a hollow blank. Alternatively, a multi-part design is also conceivable, wherein the nodal member 10 consists of a plurality of shell-shaped individual parts or member elements welded together.

The nodal member 10 is preferably T-shaped, so that a plurality of frame members can be attached on corresponding fastening flanges 34 and 36. Fastening flanges 34 and 36 also have adhesive channels (not shown) similar to the adhesive channel 18.

In addition, at least one carrier element 38 is formed on the nodal member 10. The carrier element 38 may be used for fastening body components and/or functional components (not shown) to the frame structure. The carrier element 38 is a unitary or integral part of the nodal member 10. The carrier element 38 in the present case is shown as a fastening plate with threaded bores 40 and 42 arranged therein. However, deviating from this, any other configuration is also possible.

If the vehicle frame structure is used for a driver's cab (not shown) or an agricultural commercial vehicle (not shown), the body components can be different panel and cab parts (not shown) and the functional components can be elements of a cab mounting or the like (not shown).

The fastening flange 12 of the nodal member 10 has a tapered outer contour, so that simplified pre-assembly of a frame structure through loose positioning or pushing into each other of the frame members and flanges is possible. The tapering outer contour in the present case is shaped conically.

Connecting the flange 12 to the frame member 14 is carried out in two steps. First, the frame member 14 is pushed onto the flange 12. To this end, the two parts 10 and 14 can be positioned relative to each other using an assembly gauge (not shown). To establish a mechanical joining connection, the frame member 14 is designed or dimensioned in such a manner that, when pushing-on and/or through subsequent shrinking-on of the frame member 14 or joining by thermal expansion of the nodal member 10, an elastic or plastic positive connection between the nodal member 10 and the frame member 14 is established:

Second, the adhesive 24 is injected into the adhesive channel 18 via the adhesive injection opening 26. The adhesive 24 is injected until it exits from the adhesive inspection opening 28 at the other end of the adhesive channel 18.

The adhesive 24 is a one-component methylacrylate-based adhesive or a two-component epoxy-resin-based adhesive. In addition or alternatively, the use of anaerobically or thermally curing adhesives is also possible.

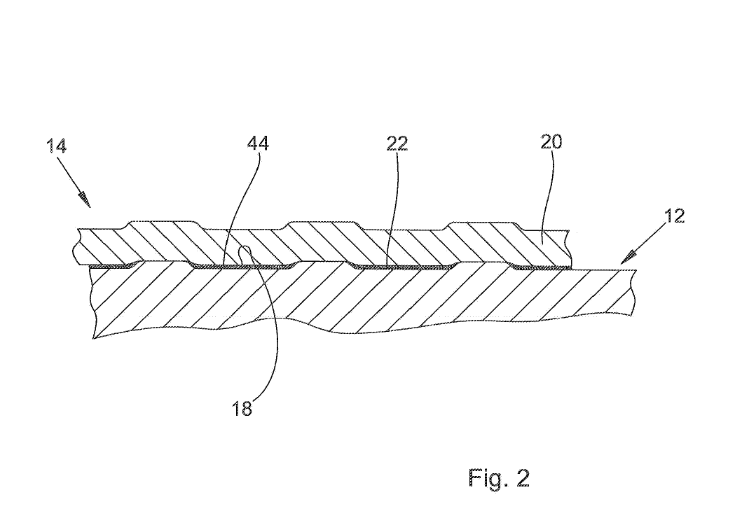

FIG. 2 shows a sectional view of a connection established between the nodal member 11 and the frame member 14. Because of the elastic or plastic positive connection established with the fastening flange 12, the frame member 14 forms a ridge 44 which is partially received in the adhesive channel 18. Preferably, the adhesive 24 completely fills the adhesive channel 18 between the frame member 14 and the flange 12. Even formation of the bead 44 is assisted by the conically tapering outer contour of the fastening flange 12.

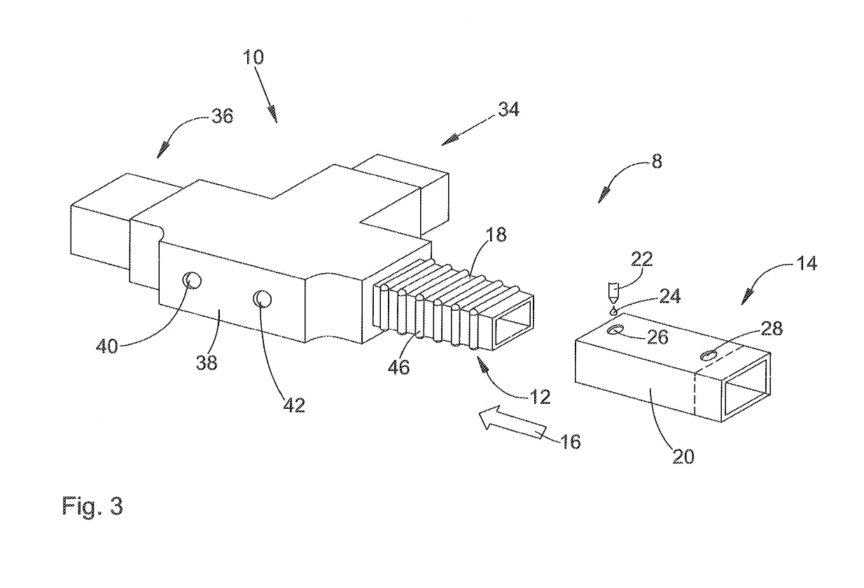

Referring now to FIG. 3, this embodiment differs from the embodiment of FIG. 2 with respect to the manner in which the adhesive channel is designed.

Accordingly, the adhesive channel 18A is formed by adjacent turns of a helical ridge 46, which runs around the outside of the flange 12. The ridge 46, formed as unitary part of the nodal member 10, has a cross section tapering towards the outside, so that, when the flange 12 is joined to the frame member 14, an adhesive bead may be formed.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A nodal member for a frame structure, having a fastening flange for connecting with a hollow frame member, characterized in that:
the fastening flange includes an adhesive channel which runs helically therearound, substantially transversely to a pushing-on direction of the frame member.

2. The nodal member of claim 1, wherein:
the adhesive channel runs on the outside of the fastening flange.

3. The nodal member of claim 1, wherein:
the adhesive channel comprises an adhesive entry region and an adhesive exit region.

4. The nodal member of claim 1, wherein:
the adhesive channel is formed by adjacent portions of a helical ridge which runs around an outer surface of the fastening flange.

5. The nodal member of claim 1, wherein:
the fastening flange has a substantially rectangular cross section with respect to the pushing-on direction.

6. The nodal member of claim 1, wherein:
the flange is manufactured unitarily as a hollow member.

7. The nodal member of claim 1, wherein:
at least one carrier element is formed on the nodal member, the carrier element being adapted to fasten components thereto.

8. The nodal member of claim 1, wherein:
the fastening flange has a tapered outer shape.

9. The nodal member of claim 1, wherein:
the adhesive channel includes an adhesive entry region which can be aligned with an adhesive injection opening formed in the frame member.

10. The nodal member of claim 1, wherein:
the adhesive channel includes an adhesive exit region which can be aligned with an adhesive inspection opening formed in the frame member.

11. A method of forming a nodal assembly having a nodal member with a flange received by a frame member, the method comprising:
pushing the frame member onto the flange, the flange having an adhesive channel formed in an outer surface thereof; and
injecting an adhesive into the adhesive channel via an adhesive injection opening formed in the frame member.

12. The method of claim 11, further comprising:
injecting the adhesive into the adhesive channel until it exits from an adhesive inspection opening formed in the frame member.

13. The method of claim 10, wherein:
the adhesive forms a bead which at least partially fills the adhesive channel.
